(19) United States
(12) Patent Application Publication
(10) Pub. No.: US 2025/0180350 A1
(43) Pub. Date: Jun. 5, 2025

(54) COORDINATE POSITIONING MACHINE

(71) Applicant: RENISHAW PLC, Wotton-under-Edge, Gloucestershire (GB)

(72) Inventor: Stephen Mark ANGOOD, Exeter (GB)

(73) Assignee: RENISHAW PLC, Wotton-under-Edge, Gloucestershire (GB)

(21) Appl. No.: 18/844,554

(22) PCT Filed: Mar. 8, 2023
(86) PCT No.: PCT/EP2023/055918

§ 371 Date: Sep. 6, 2024

(30) Foreign Application Priority Data
Mar. 11, 2022 (GB) 2203392.2

(51) Int. Cl. G01B 21/04; B25J 9/16

(52) U.S. Cl. CPC G01B 21/04; B25J 9/1679

(57) ABSTRACT

A system for calibrating or otherwise characterising a machine, including: a launch unit which is operable to launch an optical beam into a working volume of the machine; a sensor unit which is moveable by the machine to a plurality of sensor unit positions along the beam, and which is operable, for each of the plurality of sensor unit positions, to measure a transverse beam position at a plurality of measurement positions along the beam, with a position of the sensor unit relative to the beam in at least three degrees of freedom being derivable from the measurements; and a processor unit which is operable to use the measurements to calibrate or otherwise characterise the machine.

The present invention relates to a coordinate positioning machine. The present invention relates in particular, but not exclusively, to a system for calibrating or otherwise characterising at least some aspect of a coordinate positioning machine. The present invention is particularly applicable, for example, to a non-Cartesian type of coordinate positioning machine, such as a hexapod, measurement arm or articulated robot.

Articulated robots are commonly used in a wide variety of manufacturing applications such as assembly, welding, gluing, painting, picking and placing (e.g. for printed circuit boards), packaging and labelling, palletizing, and product inspection. They benefit from being versatile and rugged, with a large reach and a high degree of flexibility of movement, making them ideal for use in a production environment.

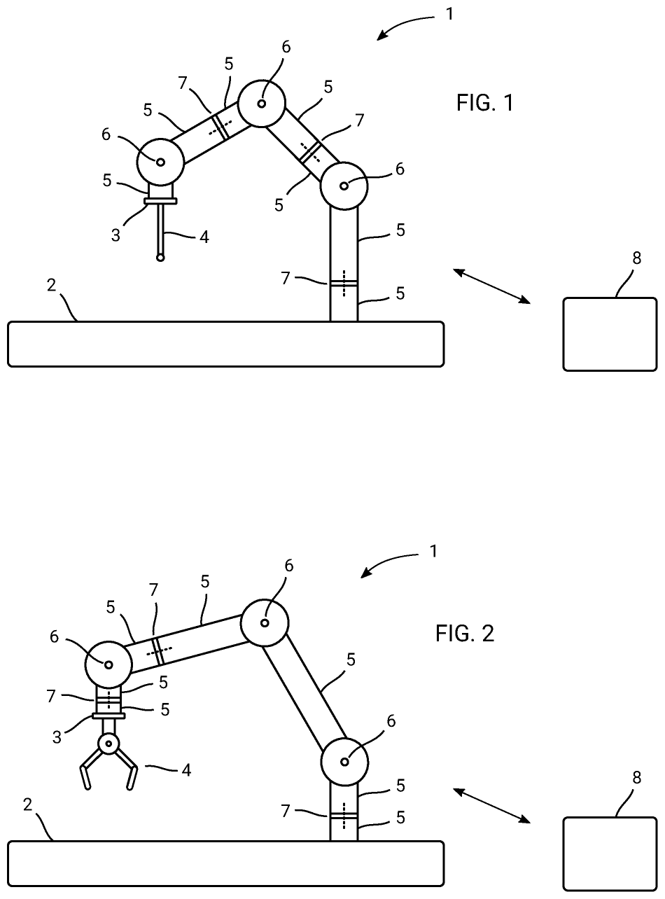

An articulated robot (or just “robot” for short) is illustrated schematically in FIG. 1 of the accompanying drawings, comprising an articulated robot arm 1 extending from a fixed base 2 to a moveable flange 3, with the flange 3 supporting a tool (or end effector) 4. Typically, the flange 3 is provided with a coupling which allows for the tool 4 to be conveniently interchangeable, so that a variety of tools or end effectors can be employed depending on the application concerned; examples include grippers, vacuum cups, cutting tools (including both mechanical and laser cutting tools), drilling tools, milling tools, deburring tools, welding tools and other specialized tools.

The arm 1 comprises a plurality of segments 5 connected by a mixture of transverse rotary axes 6 and inline (or longitudinal) rotary axes 7, forming a mechanical linkage from one end to the other. In the example illustrated in FIG. 1, there are three transverse rotary axes 6 and three inline rotary axes 7, making a total of six rotary axes, alternating between transverse rotary axes 6 and inline rotary axes 7. An additional inline rotary axis 7 (not shown in FIG. 1) could also be provided between the final transverse rotary axes 6 and the flange 3, to provide convenient rotation of the tool 4 around its longitudinal axis, making a total of seven rotary axes.

Another common arrangement is shown in the arm 1 of FIG. 2, which includes the additional inline rotary axis 7 mentioned above, between the final transverse rotary axis 6 and the flange 3, and which also omits the second inline rotary axis 7 from FIG. 1 (in series order from the base end to the head end), thereby making a total of six rotary axes. The tool 4 in FIG. 2 is a gripper. The arm 1 of FIG. 1 is a schematic representation of the well-known IRB 140 six-axis industrial robot by ABB Robotics. The final three axes 6, 7 form a “wrist” of the robot arm 1, with the centre of the wrist being at the centre of the final transverse rotary axis 6. The centre of the wrist is invariant to rotation of the three rotary axes 6, 7 of the wrist, such that operation of the three rotary axes 6, 7 changes the orientation of whatever is attached to the wrist (in this case the gripper 4) without changing the position of the wrist centre, with the first three rotary axes 6, 7 of the robot arm 1 determining the position of the wrist centre. The wrist may be readily detachable from the remainder of the arm 1.

The articulated robot arms 1 of FIGS. 1 and 2 are examples of a non-Cartesian coordinate positioning machine because, in contrast to a Cartesian machine such as a traditional three-axis (X, Y, Z) coordinate measuring machine (see for example FIG. 1 of PCT/GB2020/052593), its axes are not arranged orthogonally according to a Cartesian coordinate system. The arms 1 of FIGS. 1 and 2 are also examples of a “serial kinematic” coordinate positioning machine, because their axes of movement are arranged in series. In this sense, such a machine is similar to a traditional three-axis Cartesian coordinate measuring machine, which is also an example of a “serial kinematic” coordinate measuring machine, and is to be contrasted with a “parallel kinematic” coordinate positioning machine such as a hexapod whose axes of movement are arranged instead in parallel.

Each joint or axis in a coordinate positioning machine contributes a positional error or uncertainty. In a serial kinematic machine such as that shown in FIGS. 1 and 2, because of the serial nature of the linkages, these errors are cumulative. Whilst this accumulation of positional errors does not occur in the same sense with a parallel kinematic machine, regardless of machine type it is important to calibrate the machine in order to map out these errors or uncertainties.

Calibration of any type of non-Cartesian machine is a significant challenge, and particularly so for an articulated arm such as that illustrated in FIGS. 1 and 2 having a plurality of rotary axes that are: (a) arranged in series; (b) are not fixed relative to one another; and (c) that can combine in complicated ways to position the tool in the working volume. Calibration of a Cartesian machine is typically more straightforward, because such a machine has three well-defined axes that are fixed relative to one another in an orthogonal arrangement, with each axis being largely independent of another. With an articulated robot, the position and orientation of each axis depends on the position and orientation of each other axis, so that the calibration will be different for each different machine pose.

Many calibration techniques have in common the goal of specifying a parametric model of the machine concerned, in which a set of model parameters (also referred to as machine parameters) is used to characterise the machine's geometry. Uncalibrated values are initially assigned to these parameters as a starting point for the machine geometry. During the calibration, the machine is moved into a variety of different poses (based on the current estimates of the machine parameters). For each pose, a calibrated measuring device is used to measure the actual pose, so that an indication of the error between the assumed machine pose and the actual machine pose can be determined. The task of calibrating the machine then amounts to determining a set of values for the various machine parameters that minimises the errors, using known numerical optimisation or error minimisation techniques.

For a robot arm as illustrated in FIGS. 1 and 2, these machine parameters might include various geometrical parameters such as the length of each of the segments 5 and the rotation angle offset of each of the rotary axes or joints 6, 7 (with the angle from the encoder plus the calibrated offset giving the actual angle), as well as various mechanical parameters such as joint compliance and friction. When properly calibrated, with all of these machine parameters known, it is possible to predict with more certainty in what position the tool 4 will actually be when the various axes or joints 6, 7 are commanded by a robot controller 8 to move to different respective positions. In other words, the machine parameters resulting from such a calibration provide a more accurate characterisation of the machine geometry. These concepts, relating to calibration of coordinate positioning machines in general, and robot arms in particular, are explored in greater detail in WO 2019/162697 A1 and WO 2021/116685 A1.

Even after using known calibration techniques, due to the challenges associated with calibrating a non-Cartesian machine such as shown in FIGS. 1 and 2, errors will typically remain. As a result, the accuracy of such a machine is typically not as good as that of a traditional three-axis Cartesian machine, for example, meaning that it would typically find use for assembly (e.g. pick-and-place) tasks in a manufacturing environment, such as the arrangement illustrated in FIG. 2, where speed, reach and flexibility are more important than absolute positioning accuracy.

In view of the above, it is desirable to find an improved system for and method of calibrating a non-Cartesian coordinate positioning machine such as shown in FIGS. 1 and 2, not only to improve their positioning accuracy for existing assembly tasks but also to improve their positioning accuracy to a point where they become suitable for use as a coordinate measuring machine per se. Such a system and method can also find more general applicability to types of coordinate positioning machine other than a robot arm as illustrated in FIGS. 1 and 2.

According to a first aspect of the present invention, there is provided a system for calibrating or otherwise characterising a machine, comprising: a launch unit; a sensor unit; and a processor (or characterisation unit or calibration unit). The launch unit is operable to launch (or arrange or provide) an optical beam (or other form of optical or non-optical guide) into (or across or within) a working volume of the machine. The sensor unit is (couplable to the machine and) moveable by the machine (relative to the launch unit) to a plurality of sensor unit positions along the beam. The sensor unit is operable, for each of the plurality of sensor unit positions, to measure a transverse (or lateral) beam position (a transverse beam position being a position in a transverse plane, or in a plane that is transverse to the beam) at a plurality of measurement positions along the beam (these being the ‘measurements’ or ‘actual measurements’). A position of the sensor unit relative to the beam (or launch unit or machine), or a change in a position of the sensor unit relative to the beam (or launch unit or machine) from one of the sensor unit positions to another of the sensor unit positions, is derivable from the measurements in (each of) at least three degrees of freedom (e.g. three or four degrees of freedom). The processor unit (or characterisation unit or calibration unit) is operable to use the measurements to calibrate or otherwise characterise the machine.

In general, a first entity is moveable relative to a second entity in up to six degrees of freedom, up to three of which are translational degrees of freedom and up to three of which are rotational degrees of freedom. The three translational degrees of freedom may be denoted as X, Y, Z (corresponding to translation along X, Y, Z axes) and the three rotational degrees of freedom may be denoted as A, B, C (corresponding respectively to rotation around the X, Y, Z axes). With this coordinate system, if Z is considered to correspond to (or be aligned with) an axis defined by the beam, then: (a) X, Y are considered to be transverse translational degrees of freedom; (b) Z is considered to be a longitudinal translational degree of freedom; (c) A, B are considered to be transverse rotational degrees of freedom (also referred to as pitch, yaw); and (d) C is considered to be a longitudinal rotational degree of freedom (also referred to as roll). It will be appreciated that the allocation of letters to degrees of freedom is arbitrary, and it is also possible that rotational degrees of freedom corresponding to X, Y, Z are instead denoted as C, B, A respectively, for example.

According to a second aspect of the present invention, there is provided a sensor unit for use in a system according to the first aspect of the present invention, the sensor unit being moveable by the machine to a plurality of sensor unit positions along the beam, and which is operable, for each of the plurality of sensor unit positions, to measure a transverse beam position at a plurality of measurement positions along the beam, with a position of the sensor unit relative to the beam (or a change in a position of the sensor unit relative to the beam from one of the sensor unit positions to another of the sensor unit positions) being derivable from the measurements in at least three degrees of freedom.

According to a third aspect of the present invention, there is provided a method of calibrating or otherwise characterising a machine, comprising: (a) launching an optical beam into a working volume of the machine, or at least causing an optical beam to be launched into a working volume of the machine; (b) controlling the machine to move a sensor unit according to the second aspect of the present invention along the beam to a plurality of sensor unit positions along the beam; (c) for each of the plurality of sensor unit positions, using the sensor unit to measure a transverse beam position at a plurality of measurement positions along the beam, with a position of the sensor unit relative to the beam (or a change in a position of the sensor unit relative to the beam from one of the sensor unit positions to another of the sensor unit positions) being derivable from the measurements in at least three degrees of freedom; and (d) using the measurements to calibrate or otherwise characterise the machine.

The method may comprise repeating steps (b) and (c) for the same beam launched in step (a), or at least for a beam launched from the same position and at the same angle, but using a path for the sensor unit path that is offset from the path for the sensor unit from a previous performance of steps (b) and (c), from which combination of measurements a position of the sensor unit relative to the beam is derivable in a rotational (roll) degree of freedom around an axis defined by the beam.

A movement of the sensor unit along the beam to collect measurement data as part of a method embodying the present invention is also referred to herein as a “run”.

A position of the sensor unit relative to the beam may be derivable (from the measurements) in two transverse translational degrees of freedom (translational degrees of freedom along first and second transverse axes to the beam, or along first and second axes that are transverse to the beam) and at least one transverse rotational degree of freedom (at least one rotational degree of freedom around a transverse axis to the beam, or around an axis that is transverse to the beam, which axis may be the same as one of the first and second transverse axes). An axis defined by the beam may be denoted as the Z axis, with the two transverse translational degrees of freedom being X, Y, and the at least one transverse rotational degree of freedom being at least one of A, B (at least one of pitch, yaw).

A position of the sensor unit relative to the beam in the transverse rotational degree of freedom may be derivable from (the measurements from) a corresponding pair of measurement positions that are spaced apart by a fixed and/or known and/or measured separation. Each measurement position of the pair may provide measurements in or along the same direction and/or dimension. Each measurement position of the pair may provide measurements from which a position in or along the same direction and/or dimension can be derived. The pair of measurement positions may be spaced apart by a fixed but unknown or unmeasured separation, or at least spaced apart by a separation that is only known or measured to a certain level of accuracy (e.g. to an accuracy no greater than the actual separation, or no greater than 50% of the actual separation, or no greater than 10% of the actual separation, or no greater than 5% of the actual separation, or no greater than 1% of the actual separation, or no greater than 0.1% of the actual separation).

A position of the sensor unit relative to the beam may be derivable in two transverse rotational degrees of freedom, for example in both A and B, or for both pitch and yaw.

The sensor unit may be further operable to provide further measurements from which a position of the sensor unit relative to the beam is derivable in a longitudinal rotational degree of freedom (e.g. around an axis defined by the beam, or the Z axis). This degree of freedom may be referred to as roll. These measurements may be provided by a dedicated roll sensor (such as described in described in WO 2008/122808) or from two offset runs along the same beam as described herein.

The processor unit may be operable to calibrate or otherwise characterise the machine in dependence on a comparison between expected measurements from the sensor unit (or information such as relative positional information derived from the measurements) and the actual measurements from the sensor unit (or information such as relative positional information derived from the actual measurements). In this context, expected can be considered to mean expected based on a set of model parameters which characterises the geometry of the machine.

The system may comprise a control unit that is operable to control the machine to move the sensor unit along the beam. The control unit may be operable to control the machine to move the sensor unit along the beam based on a set of model parameters (of a parametric model) which characterises the geometry of the machine. The control unit that may be operable to produce a series of position demands to control the machine to move in this way.

The processor unit may be operable to update the model parameters (of the parametric model) based on the comparison mentioned above. This may be performed to provide a closer match between expected and actual measurements.

In doing so, the intention is that the new set of model parameters thereby characterises the geometry of the machine better than the existing set of model parameters.

The control unit may be operable to control movement of the machine (for at least part of the movement) to cause the sensor unit to follow a predetermined path along the beam, at least in the absence of any additional movement applied or imposed e.g. by a servo mechanism. The path of the sensor unit may define both the position and orientation of the sensor unit relative to the beam.

The control unit may be operable (in cooperation with the processor unit) to servo movement of the machine (for at least part of the movement) in dependence on the measurements from the sensor unit to maintain (or at least to attempt to maintain) substantially constant (or otherwise known or predetermined) measurements from the sensor unit for each of the sensor unit positions along the beam. The servo movement may be applied in addition to or combination with any movement along a predetermined path.

The separation may be measured by moving the sensor unit relative to the launch unit such that the beam is incident at each measurement position of the pair in turn, with the separation being determined based on the model parameters.

The processor unit may be separate from (e.g. at a separate location to) the control unit, or these may effectively be one and the same (or at least provided by the same unit).

The sensor unit may comprise a sensor at each of the measurement positions, each sensor being adapted to sense (or measure an incident position of) the beam in one or two transverse dimensions or directions.

The sensor unit may have multiple entry points for the beam at different respective angles while still passing through the same measurement positions.

A coupling between the sensor unit and the machine may be adapted to place at least one of the measurement positions substantially coincident with a point of interest associated with the machine.

The point of interest associated with the machine may be a tool centre point (for a tool mounted to the machine).

A coupling between the sensor unit and the machine may be adapted to provide for rotation of the sensor unit relative to the machine around a predetermined point on the coupling. The predetermined point is preferably arranged to be substantially coincident with the point of interest (e.g. tool centre point).

The launch unit may be operable to launch the beam into the working volume of the machine from multiple positions and/or in multiple directions.

The sensor unit may be moved by the machine (e.g. coupled to a head end of the machine) while the launch unit is fixed (during the movement, e.g. coupled to a base platform of the machine). Alternatively, the launch unit may be moved by the machine (e.g. coupled to a head end of the machine) while the sensor unit is fixed (during the movement, e.g. coupled to a base platform of the machine).

The optical beam may be a laser beam or a light beam. However, it will be appreciated that the optical beam is effectively acting as an optical guide that can be sensed by an appropriate form of optical sensor in the sensor unit, and the present invention is not limited to the use of an optical beam as the guide. Some other type of energy beam could be used instead, such as an electron beam, with use of appropriate sensors in the sensor unit depending on the type of energy beam used. Preferably a non-contact form of guide is used, but a mechanical guide could also be used, such as a metal rod or a straight edge of a metal sheet (like a ruler). In the more general case, the phrase “launching an optical beam into the working volume” can be replaced by the phrase “arranging a guide within the working volume”. The guide (which can also be referred to as a sensor unit guide or a guide for a sensor unit) need not define a straight path, it merely being required that the path defined by the guide is of a known form; for example, the guide could have a known radius of curvature.

The system may further comprise a linear measurement device for providing measurements relating to a longitudinal (linear) translational degree of freedom. This would thereby enable up to five degrees of freedom to be determined from the sensor unit, with an additional degree of freedom being determined from this measurement device, thereby providing a system capable of characterising the machine based on up to six degrees of freedom.

The sensor unit may comprise means (e.g. a reflector) for returning at least a proportion of the beam back to the launch unit (or some other receiver unit), and wherein the launch unit (or other receiver unit) comprises an interferometric sensor which uses a reference beam and the return beam to provide measurements relating to a longitudinal (linear) translational degree of freedom. This would thereby enable up to five degrees of freedom to be determined from the sensor unit, with an additional degree of freedom being determined from this measurement device, thereby providing a system capable of characterising the machine based on up to six degrees of freedom.

Characterising the machine may comprise one or more of: calibrating the machine; verifying the machine; performing a health check of the machine; evaluating positioning errors of the machine; and setting up the machine.

Where the geometry of the machine is characterised by a set of model parameters, calibrating the machine may comprise determining a new set of model parameters that characterises the geometry of the machine better than an existing set of model parameters.

The machine may comprise (or be) a coordinate positioning machine. The machine may comprise (or be) a non-Cartesian and/or parallel kinematic machine. The machine may comprise (or be) a robot arm.

Each of the features described above in relation to the first aspect of the present invention also apply, where appropriate, to each of the further aspects of the present invention set out below.

According to fourth aspect of the present invention, there is provided a directional sensor unit that is mountable to a non-Cartesian machine in a fixed orientation to perform a method for characterising the machine, and which is moveable between a plurality of different fixed orientations relative to the machine to enable the method to be performed with the machine in a plurality of different configurations (or poses) for the same sensing operations.

According to a fifth aspect of the present invention, there is provided a method of calibrating or otherwise characterising a non-Cartesian coordinate positioning machine, comprising: (a) launching an optical beam into a working volume of the machine, or at least causing an optical beam to be launched into a working volume of the machine; (b) controlling the machine to move a sensor unit along the beam to a plurality of sensor unit positions along the beam; (c) for each of the plurality of sensor unit positions, using the sensor unit to take measurements from which a position of the sensor unit relative to the beam is derivable in at least three degrees of freedom; (d) repeating steps (a) to (c) for a plurality of different launch positions and/or angles for the beam; and (e) using the measurements to calibrate or otherwise characterise the machine. The sensor unit may be one according to the second aspect of the present invention, or it may be another type of sensor unit.

According to a sixth aspect of the present invention, there is provided a computer program which, when run by a computer or a machine controller, causes the computer or machine controller to perform a method according to the third or fifth aspect of the present invention (or at least any steps of the method that can be performed or caused to be performed by the computer program).

According to another aspect of the present invention, there is provided a computer-readable medium having stored therein computer program instructions for controlling a computer or a machine controller to perform a method according to the third or fifth aspect of the present invention (or at least any steps of the method that can be performed or caused to be performed by the computer program).

According to another aspect of the present invention, there is provided a machine controller configured to control a machine to perform a method according to the third or fifth aspect of the present invention (or at least any steps of the method that can be performed or caused to be performed by the controller).

Reference will now be made, by way of example, to the accompanying drawings, in which:

FIG. 1, discussed hereinbefore, is a schematic illustration of a coordinate positioning arm in the form of an articulated robot;

FIG. 2, also discussed hereinbefore, is a schematic illustration of an articulated robot having a different arrangement of rotary axes to that of FIG. 1;

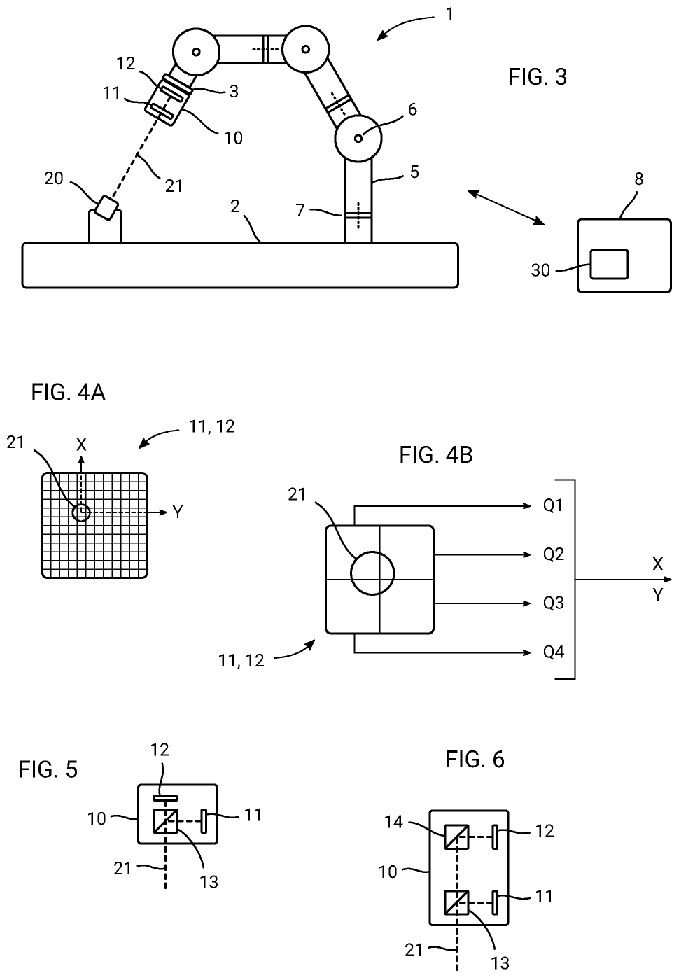

FIG. 3 is a schematic illustration of a system embodying the present invention for calibrating a coordinate positioning machine in the form of an articulated robot arm;

FIGS. 4A and 4B illustrate two possible types of two-dimensional sensor for use in a sensor unit embodying the present invention;

FIG. 5 illustrates a sensor unit having an alternative sensor arrangement to that shown in FIG. 3;

FIG. 6 illustrates a sensor unit having an alternative sensor arrangement to that shown in FIGS. 3 and 5;

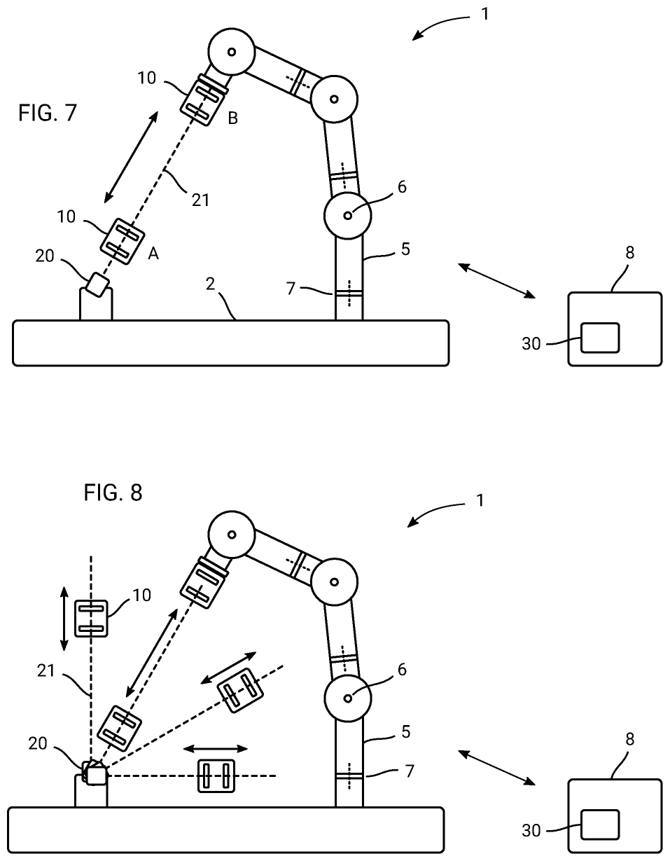

FIG. 7 illustrates how, in a method embodying the present invention, measurement data is collected from the sensor unit as it is moved along the laser beam by the robot arm;

FIG. 8 illustrates how additional measurement data can be collected by repeating the process for a plurality of different beam orientations;

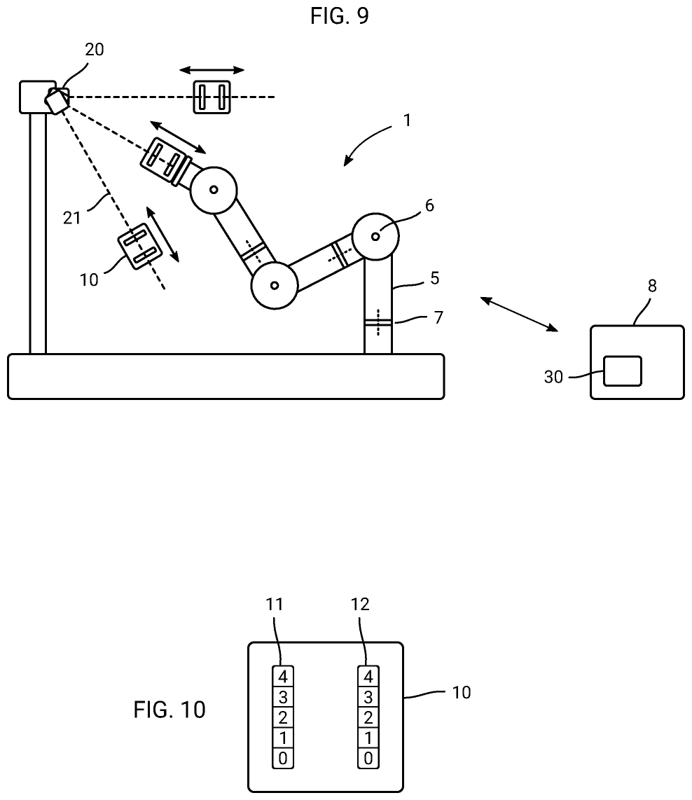

FIG. 9 illustrates how additional measurement data can be collected by repeating the process for a plurality of different beam positions and orientations;

FIG. 10 shows a simplified form of sensor unit having two one-dimensional sensors for ease of explanation;

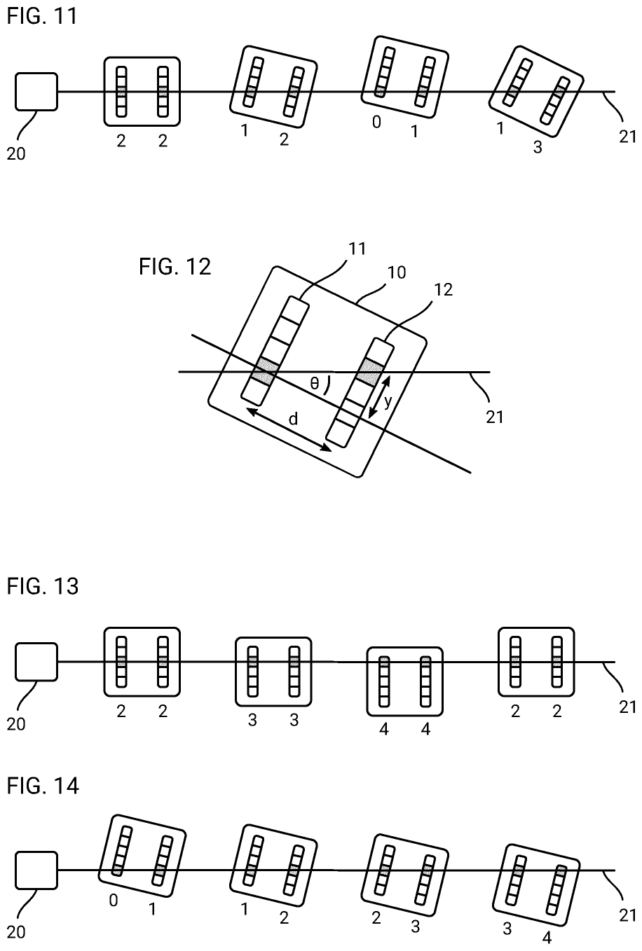

FIG. 11 illustrates the sensor unit of FIG. 10 being moved along the laser beam according to a predetermined path but with some unwanted translational and rotational deviations from that path;

FIG. 12 is for explaining how a rotational deviation can be determined based on the measured lateral beam position from the two sensors of the sensor unit;

FIG. 13 illustrates the sensor unit of FIG. 10 being moved along the laser beam according to a predetermined path but with some unwanted translational deviations from that path;

FIG. 14 illustrates that the predetermined path for the sensor unit of FIG. 10 need not be one that is intended to maintain the sensor unit perfectly aligned with the laser beam along its length;

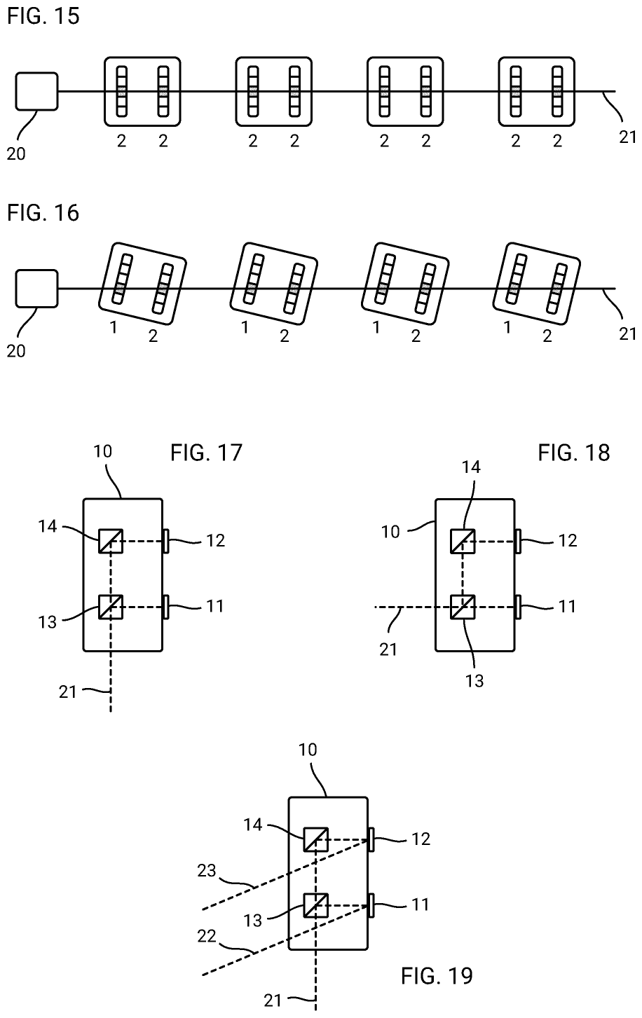

FIG. 15 illustrates the sensor unit of FIG. 10 being moved along the laser beam according to a predetermined path but with a superimposed servo movement which corrects for unwanted translational and rotational deviations to maintain the sensor unit aligned with the beam;

FIG. 16 illustrates that the superimposed servo movement for the sensor unit of FIG. 10 could be aimed at maintaining the sensor unit at a constant angle relative to the beam rather than perfectly aligned with the beam;

FIG. 17 shows a sensor unit similar to that shown in FIG. 6 but with sensors conveniently mounted externally;

FIG. 18 shows an alternative entry path for the laser beam into the sensor unit of FIG. 17 to enable a calibration run to be repeated along the same beam with the head at a different angle;

FIG. 19 is for use in explaining a method of measuring the separation between the sensors in the sensor unit of FIG. 17;

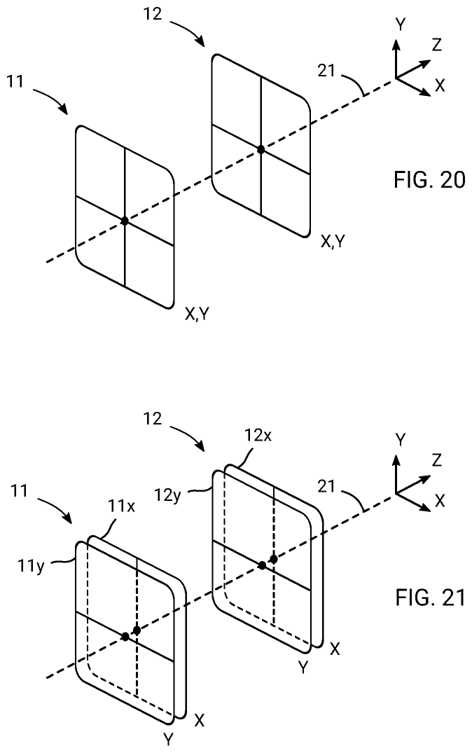

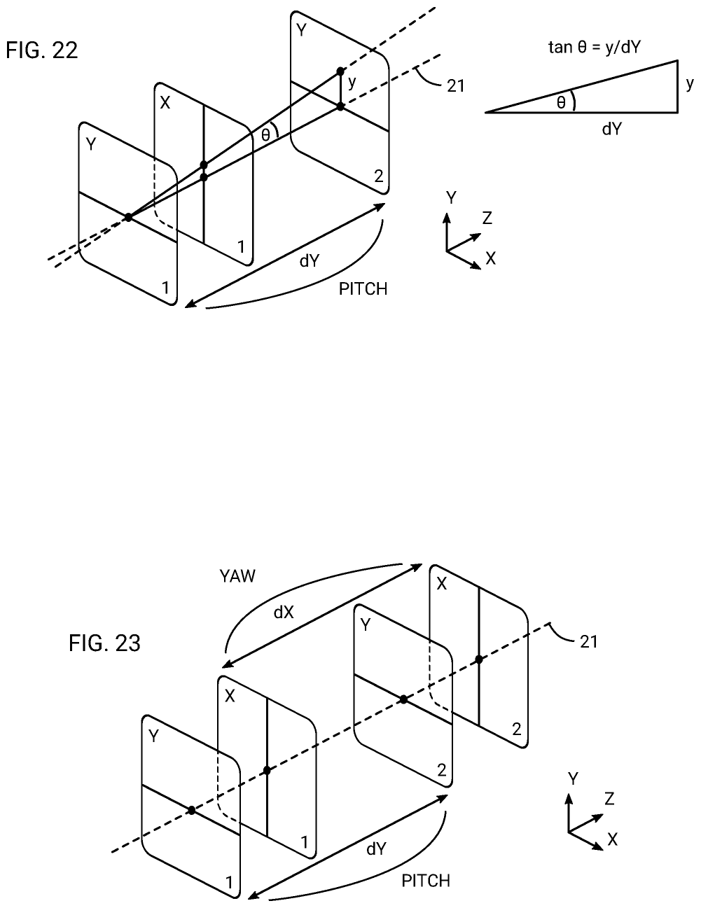

FIG. 20 is a three-dimensional representation of two two-dimensional sensors that form part of a sensor unit embodying the present invention for measuring relative motion in four degrees of freedom;

FIG. 21 is a three-dimensional representation of four one-dimensional sensors that form part of a sensor unit embodying the present invention for measuring relative motion in four degrees of freedom;

FIG. 22 is a diagram illustrating the use of three measurement positions from which relative motion can be determined in three degrees of freedom including pitch;

FIG. 23 is a diagram illustrating the use of four measurement positions from which relative motion can be determined in four degrees of freedom including pitch and yaw;

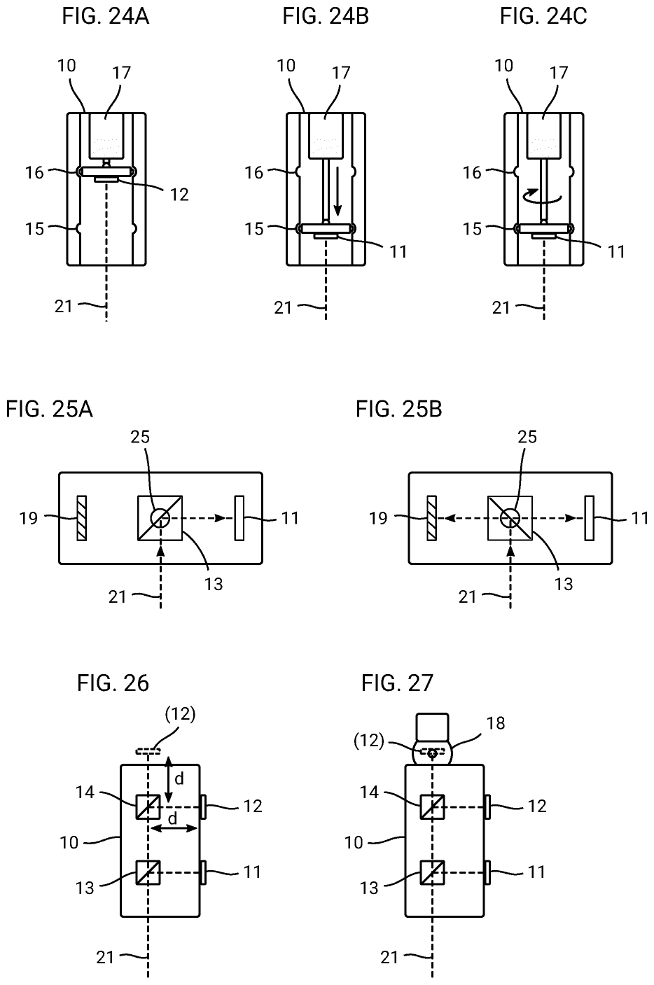

FIGS. 24A to 24C schematically illustrate how a single sensor can be moved between multiple measurement positions rather than having a sensor at each measurement position;

FIGS. 25A and 25B schematically illustrate the use of a movable optical component to create multiple measurement positions for a static sensor;

FIG. 26 illustrates shows the effective inline position of the distal sensor when the optical path of the reflected beam is unfolded;

FIG. 27 shows a sensor unit having a rotary joint with a rotation centre that is coincident with the effective position of the distal sensor of the sensor unit;

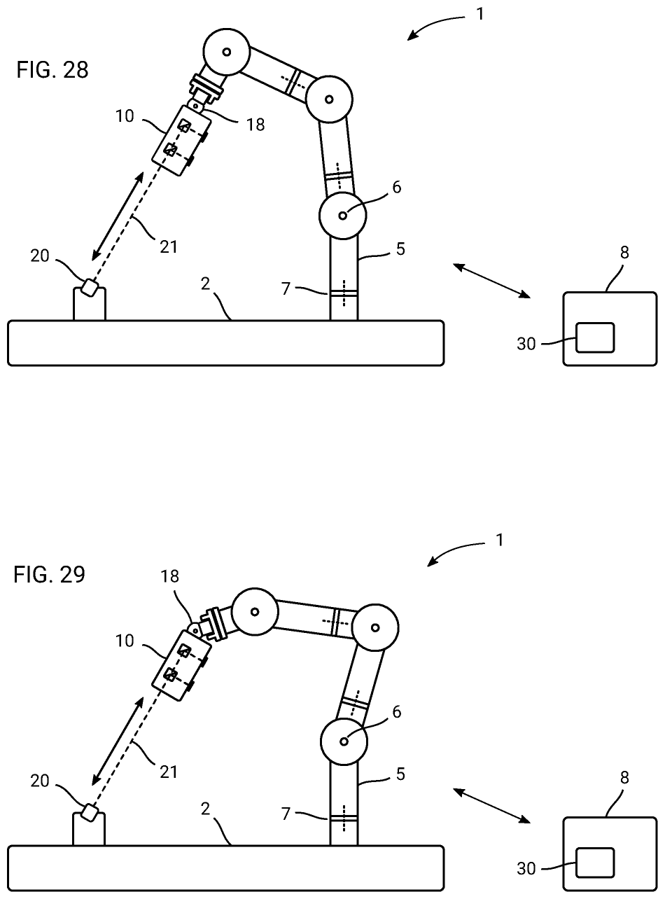

FIG. 28 shows the sensor unit of FIG. 27 coupled to the robot arm via the rotary joint and being moved along the laser beam as part of a calibration routine;

FIG. 29 illustrates how the rotary joint can be used to change the mounting angle of the sensor unit so that additional calibration data can be collected along the same laser beam;

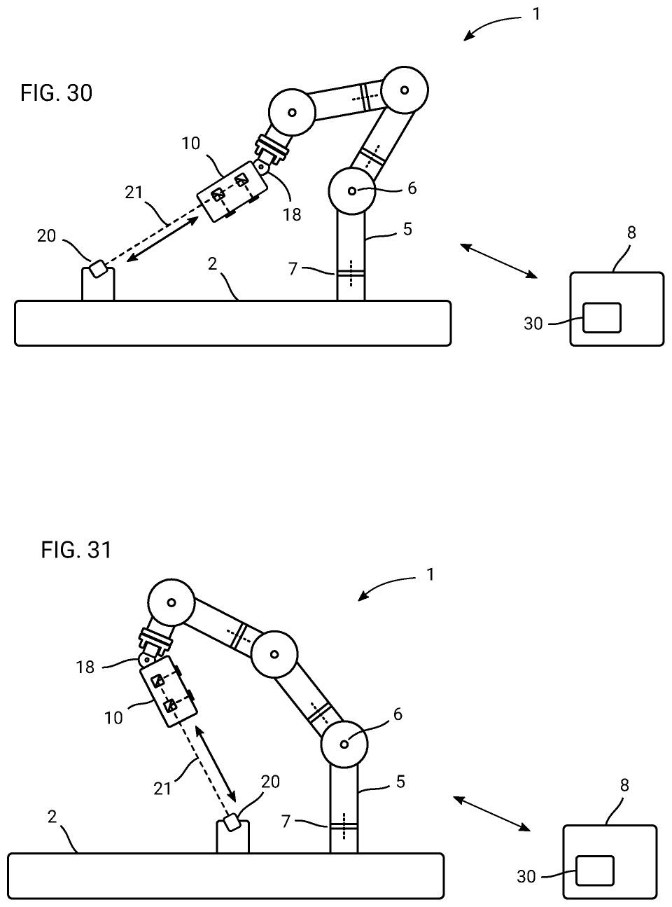

FIG. 30 shows additional calibration data being collected after changing the direction of the laser beam and with the sensor unit mounted at a different angle via the rotary joint;

FIG. 31 shows additional calibration data being collected after changing both the position and the direction of the laser beam and with the sensor unit mounted at a different angle via the rotary joint;

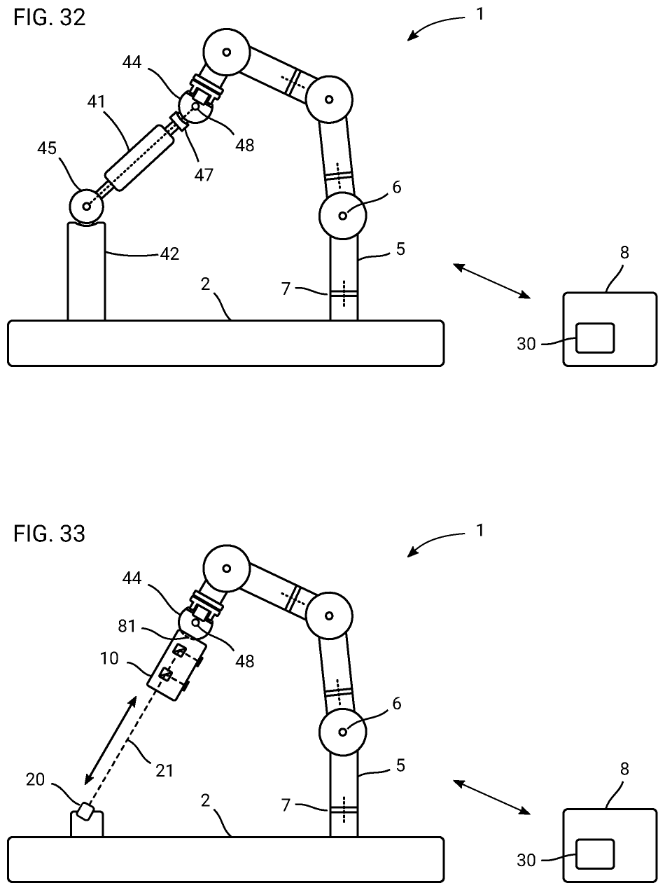

FIG. 32 shows a separate linear measurement device coupled to the robot arm via a ball adaptor for collecting calibration data relating to an additional degree of freedom; and

FIG. 33 shows how the sensor unit can itself be mounted to the robot arm via the ball adaptor of FIG. 32;

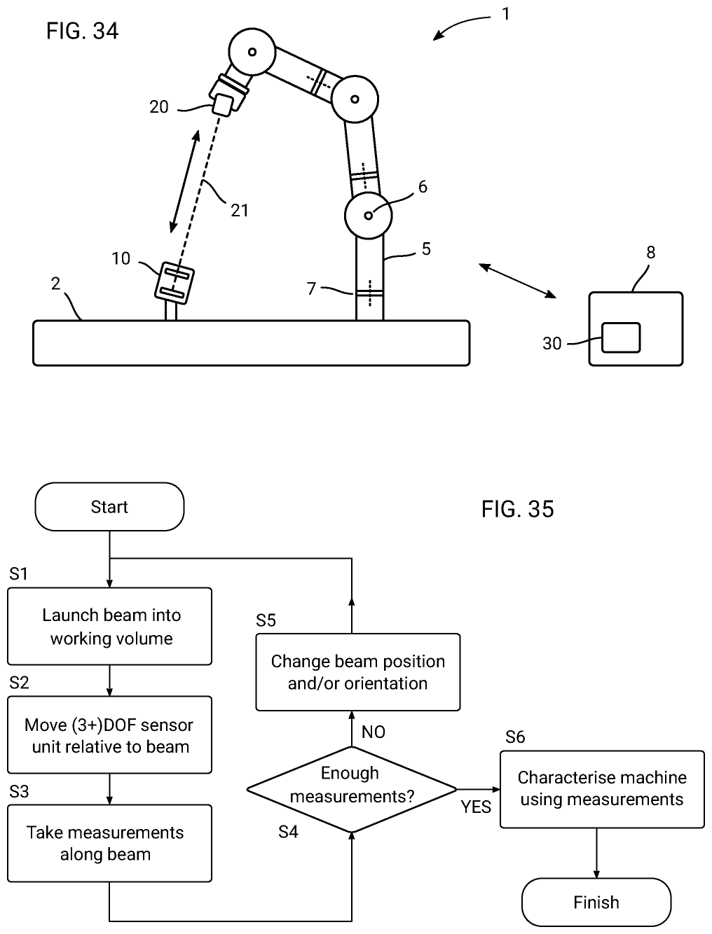

FIG. 34 illustrates an alternative arrangement in which the sensor unit if coupled to the fixed base of the machine and the launch unit is coupled to the moving part of the machine;

FIG. 35 illustrates in flowchart form a method of calibrating or otherwise characterising a machine according to an embodiment of the present invention;

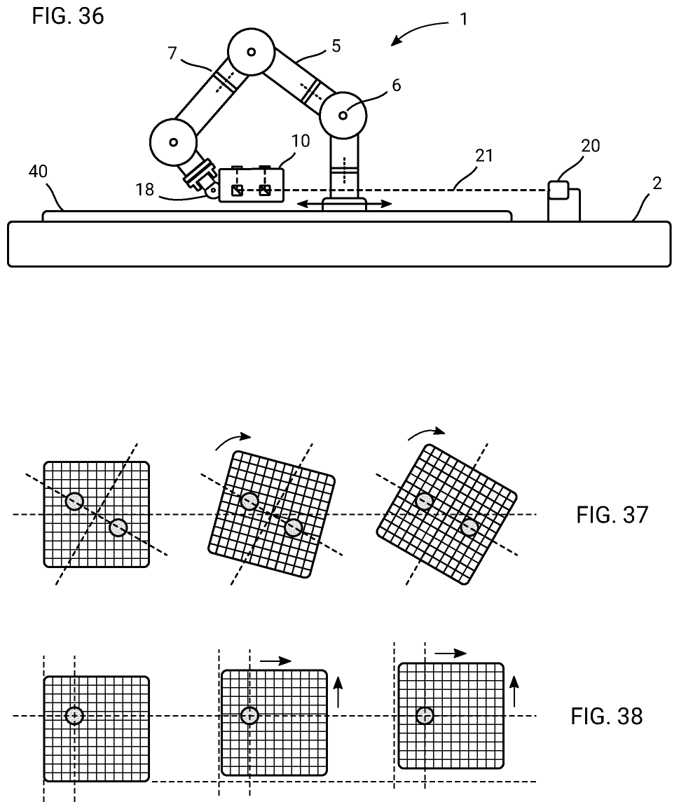

FIG. 36 illustrates the application of an embodiment of the present invention to the characterisation of a linear axis provided by a rail along which the robot arm is moveable;

FIG. 37 shows how performing two runs along the same beam, with the sensor unit at different respective lateral or radial or transverse positions relative to the beam, can be used to determine a roll degree of freedom; and

FIG. 38 illustrates how the same sensor readings as FIG. 37 might be interpreted as a translation if measurement data from just one of the beam runs were used to characterise the machine.

FIG. 3 shows a robot arm 1 that is generally similar to that described above with reference to FIGS. 1 and 2, having a plurality of segments 5 connected by a combination of transverse rotary axes 6 and inline rotary axes 7. FIG. 3 also shows a calibration system according to an embodiment of the present invention for calibrating the robot arm 1. The calibration system comprises a sensor unit 10, launch unit 20 and processor unit 30.

The launch unit 20 is operable to launch a laser beam 21 into a working volume of the robot arm 1. The sensor unit 10, which is coupled to the robot arm 1 via a flange 3, is moveable relative to the launch unit 20 by the robot arm 1 to a plurality of sensor unit positions along the beam 21, with this relative motion being controlled by the controller 8.

The sensor unit 10 comprises first and second two-dimensional sensors 11, 12 for measuring a transverse (or lateral) two-dimensional position of the beam 21 within the sensor unit 10, i.e. a two-dimensional position of the beam 21 in a plane that is transverse (e.g. orthogonal) to the beam 21 at two corresponding measurement positions along the beam 21.

An example two-dimensional sensor 11, 12 is shown in FIG. 4A, comprising a two-dimensional array of sensor pixels. When the beam 21 is incident on the sensor 11, 12, the two-dimensional transverse position X, Y of the beam 21 can be determined based on the row and column of the sensor pixel having the strongest response.

Alternatively, instead of using a dense two-dimensional array of sensor pixels as shown in FIG. 4A, a two-dimensional sensor based on a quad cell design can be used as illustrated in FIG. 4B. There are four output signals Q1, Q2, Q3 and Q4 from the sensor 11, 12, and from the relative strengths of these output signals a two-dimensional transverse X, Y position of the incident beam 21 can be determined using well-known equations.

As another alternative, a position-sensitive detector (PSD) can be used for sensors 11, 12. This type of detector has a single isotropic sensing region, rather than four or more discrete sensing regions as per FIGS. 4A and 4B. Typically, a PSD will have four outputs, like the quad cell sensor of FIG. 4B, with the incident beam 21 causing a change in local resistance and thus also a change in electron flow (current) in the four outputs. From the four output signals, the two-dimensional transverse X, Y position of the incident beam 21 can again be computed using well-known equations.

With the sensor unit 10 shown in FIG. 3, the laser beam 21 is incident first (at a first measurement position) on the first sensor 11 and then (at a second measurement position) on the second sensor 12, with the beam 21 passing through the first sensor 11 to reach the second sensor 12 behind the first sensor 11. Whilst this is possible, for example with the use of a semi-transparent detector for the first sensor 11, FIG. 5 shows an alternative optical arrangement for the sensor unit 10 which uses a beam splitter 13 and the sensors 11, 12 at right angles and at different respective spacings from the beam splitter 13. This is optically equivalent to the inline version of the sensor unit 10 as shown in FIG. 3, whilst avoiding the need for a semi-transparent detector. Another configuration for the sensor unit 10 is shown in FIG. 6, using a beam splitter 13 to direct a proportion of the beam 21 to the first sensor 11, which is arranged to one side of the sensor unit 10 at right angles to the incoming beam 21, and a mirror 14 arranged in the optical path of the beam 21 beyond the beam splitter 13, for directing the remainder of the beam 21 to the second sensor 12, also positioned to one side of the sensor unit 10. It will be appreciated that the second sensor 12 need not be at right angles to the incoming beam 21, and it could also be arranged to the other side of the sensor unit 10 compared to the first sensor 11. Other configurations for the sensor unit 10 are discussed further below (for example, see FIGS. 24A to 24C and FIGS. 25A and 25B). A particular advantage associated with the sensor unit 10 of FIG. 6 is discussed further below with reference to FIGS. 26 and 27.

A method of calibrating the robot arm 1 using the sensor unit 10 will now be described with reference to FIG. 7. The controller 8 is first used to control the robot arm 1 to move the sensor unit 10 towards a lower end of the beam 21. The controller 8 then adjusts the position of the sensor unit 10 relative to the beam 21 until the beam 21 is centred on both sensors 11, 12. In this sensor unit position A, with the beam 21 passing through the centre of both sensors 11, 12, it is known that the sensor unit 10 is aligned with the beam 21. The machine coordinates for this sensor unit position A are recorded.

The controller 8 is then used to control the robot arm 1 to move the sensor unit 10 towards an upper end of the beam 21. The controller 8 then adjusts the position of the sensor unit 10 relative to the beam 21 until the beam 21 is again centred on both sensors 11, 12 (the “null position” or “null pose”). In this sensor unit position B, with the beam 21 passing through the centre of both sensors 11, 12, it is known that the sensor unit 10 is again aligned with the beam 21. The machine coordinates for this sensor unit position B are recorded.

At sensor unit position B, rather than rotating the sensor unit 10 to align the beam 21 with the centre of both sensors 11, 12, it would also be possible to maintain the same orientation for the sensor unit 10 (i.e. that same as for other position A) and merely command the robot 1 to adjust the X, Y, Z position of the sensor unit 10 so as to align just one of the sensors 11, 12 with the beam 21 (e.g. that one of the sensors 11, 12 which is being treated as the reference for the coordinate system X, Y, Z, A, B, C of the sensor unit 10, for more on which see the discussion further below with reference to FIG. 12). Any misalignment at the other of the sensors 11, 12 is likely to be sufficiently small not to present any problem. This is beneficial because it is then relatively straightforward to command the robot to adjust only the X, Y, Z position of the sensor unit 10 to move it between sensor unit positions along the beam 21, and not also the A, B, C orientation of the sensor unit 10. Preferably the sensor 11, 12 that is used as a reference for this translation in X, Y, Z is also arranged to be coincident with the tool centre point (TCP), as discussed below with reference to FIGS. 28 to 31.

A path for the sensor unit 10 is then calculated by the controller 8 which will attempt to move the sensor unit 10 in a straight line from position B to position A, keeping the sensor unit 10 perfectly aligned with the beam 21 at all times. This path is determined based on the existing machine parameters, and therefore although it is expected (based on these machine parameters) that the sensor unit will remain aligned with the beam 21 as it is moved along the beam, in reality it will not do so because the machine parameters will not be a perfect representation of the geometry of the machine. It is the aim of the calibration method to produce a new set of machine parameters which will better represent the geometry of the machine, thereby leading to an improved calibration.

The controller 8 is then used to control the robot arm 1 to move the sensor unit 10 relative to the launch unit 20 along the calculated path, starting at sensor unit position B and ending at sensor unit position A, with the sensor unit 10 passing through a plurality of intermediate sensor unit positions. At each of these intermediate sensor unit positions the machine coordinates (i.e. the rotary encoder readings representing all rotary joint angles) are recorded along with the transverse two-dimensional measurements from both sensors 11, 12.

If the calibration were ideal, the beam 21 would remain perfectly centred on both sensors 11, 12 at each of the intermediate sensor unit positions, i.e. the transverse position would always be X=0 and Y=0. However, in practice the calibration will not be ideal and the transverse position of the beam 21 on the sensors 11, 12 will vary away from X=0 and Y=0.

When all measurements from sensors 11, 12 have been collected from the run from sensor unit position B to sensor unit position A, the measurements are passed to the processor unit 30. The processor unit 30 performs a numerical optimisation or error minimisation routine as described previously, which involves a comparison between the actual measurements from the sensor unit 10 and the expected measurements from the sensor unit 10 (i.e. as expected based on the existing set of model parameters which characterises the geometry of the machine). Based on this comparison, the processor unit 30 updates the model parameters so as to provide a closer match between the expected measurements (i.e. as expected based on the new set of model parameters) and the actual measurements (from the previous run). In other words, the updated model parameters represent the geometry of the machine better than the previous version of the model parameters.

For example, if the programmed path from B to A (or vice versa) is expected to produce sensor readings of X=0 and Y=0 for every sensor unit position (because the path is programmed to make this so, at least in theory), while the actual sensor readings for one of the sensor unit positions are X=3 and Y=2, then after the model parameters have been optimised the expected sensor readings for the same set of actuator position demands (i.e. the commanded angles for each of the rotary joints) should be closer to X=3 and Y=2 (rather than X=0 and Y=0) as before. However, it is to be noted that an error minimisation routine is attempting to minimise an overall error across all of the calibration data, so it is possible that some expected measurements will drift slightly further away from the actual measurements, while many others will move closer (so that the overall calibration is improved).

To improve the calibration further, several runs can be performed with the laser beam 21 being launched into the working volume of the machine in a different direction for each run, as illustrated in FIG. 8, and with the measurements from all of the runs being fed into the numerical optimisation or error minimisation routine. This leads to a more thorough calibration because the robot arm 1 is being moved into many more different poses or configurations, with calibration data being collected for many more different combinations of rotary joint angle. The calibration can be improved even further by moving the launch unit 20 to one or more different launch positions and collecting more measurement data from each of these launch positions, preferably with the beam 21 being launched at a plurality of different angles for each launch position, as is illustrated in FIG. 9.

To illustrate the concept of expected measurements vs actual measurements in the above method, a simplified representation of sensor unit 10 is shown in FIG. 10, with each sensor 11, 12 being shown as a one-dimensional sensor having five different positions 0 to 5. FIG. 11 shows the sensor unit 10 in several sensor unit positions along the beam 21, starting at [2, 2] (i.e. the beam 21 is incident at a lateral position of 2 on the first sensor 11 and also the second sensor 12). This is the “null” starting position A as described above, with the sensor unit 10 aligned with the beam 21. However, for the next three sensor unit positions the sensor readings are [1, 2] then [0, 1] and then [1, 3], whereas the expected sensor readings for each sensor unit position are [2, 2]. Therefore, instead of a pure linear motion of the sensor unit 10 relative to the beam 21, an unwanted relative rotation has been introduced, due to a non-ideal calibration of the robot arm 1. A comparison between expected and actual sensor readings is as follows, in this simple example being determined as “actual minus expected”: [0, 0] [−1, 0] [−2, −1] [−1, 1]. After the model parameters have been optimised, this would ideally be [0, 0] for each sensor unit position.

The amount of unwanted rotation, and therefore the amount of correction that would need to be applied in the calibration to nullify that unwanted rotation, can be determined by comparing (i.e. taking a difference between) the lateral position of the beam 21 on respective sensors 11, 12, and also taking account of the separation between the sensors 11, 12. As illustrated in FIG. 12, if the difference in lateral position from one sensor to the other is denoted as ‘y’ and the separation between sensors is denoted as ‘d’, then using simple trigonometry the relationship between these is:

$$tan θ = \frac{y}{d}$$

And therefore:

$$θ = {tan}^{- 1} ( \frac{y}{d} )$$

Accordingly, in order to determine angular information, it is necessary to know the separation ‘d’ between the sensors 11, 12. However, it is to be noted that it is not generally required to know this separation to a high degree of accuracy, since this angular information is used in the error minimisation routine to determine what magnitude of adjustment needs to be made (and in what direction) for each iteration of the iterative routine, for example when performing a gradient descent type of algorithm, and it is possible to make smaller steps in the gradient descent rather than larger ones (for example if there is some uncertainty regarding the accuracy of the angular information) though it would take longer to reach a stable state (i.e. to find a local minimum in the error minimisation routine). A method for determining the separation between the sensors 11, 12 is explained further below.

The transverse position of the sensor unit 10 relative to the beam 21 can be derived from the measurement from sensor 11, or the measurement from sensor 12, or a combination of measurements from sensors 11, 12. It can be convenient to place a centre of the coordinate system for the sensor unit 10 (e.g. X, Y, A, B when considering four degrees of freedom) on one of the sensors 11, 12, so that only one of the sensors 11, 12 is then used to determine a transverse position X, Y and a combination of sensors is used to determine an angular position A, B (or transverse position X and angular position A in the simplified one-dimensional example of FIG. 12). For example, in FIG. 12 the transverse position X would be 1 (i.e. where the beam 21 is incident on sensor 11) and the angular position A would be 0 (determined as stated above based on a combination of a transverse position of 1 from sensor 11 and a transverse position of 3 from sensor 12). It can be convenient to align the coordinate system with that one of the sensors 11, 12 that lies closest to the machine 1, so that in FIG. 3 this would be sensor 12 rather than sensor 11, but either of these is possible. This concept is explored further with reference to FIGS. 28 to 31.

FIG. 13 shows another example in which the actual measurements are [2, 2] [3, 3] [4, 4] [2, 2], with the comparison being [0, 0] [1, 1] [2, 2] [0, 0], so that in this case there is no unwanted rotation (no rotational error) but there is some linear drift (linear error). Again, after optimisation this linear drift will ideally have been calibrated out, such that the comparison would be [0, 0] at each sensor unit position. The example presented in FIG. 14 shows that it is not necessary to start and end each run with the beam 21 centred on both sensors 11, 12, and instead any calibration path can be programmed that maintains the beam incident on both sensors throughout the run. In FIG. 14, a linear path is programmed to start with the sensor readings on [0, 1] and end with the readings on [3, 4]. If the actual readings along the path are as shown in FIG. 14, i.e. [0, 1] [1, 2] [2, 3] [3, 4] then the sensor unit 10 has moved along the beam without any rotational or translational drift, and the calibration cannot be improved in this example.

With the calibration method described above, the sensor unit 10 is moved along a pre-programmed path from one end of the laser beam 21 to the other, with measurement data from the sensor unit 10 being collected at each sensor unit position along the path. For an imperfect calibration, the actual sensor measurement data will be deviating from the expected sensor measurement data along the path, and it is the aim of the calibration method to analyse these deviations so as to produce a calibration that will (in subsequent runs or in subsequent operational use of the robot arm 1) eliminate or at least reduce those deviations. Rather than allow these deviations to occur during the calibration method, another approach is to adjust or servo the movement of the robot actively during a calibration run so as to attempt to keep the sensor unit 10 aligned with the beam 21 at all times, rather than let it drift off as shown in FIGS. 11 and 13.

With this alternative approach, a path is programmed as before, and the control unit 8 operates to move the sensor unit 10 along this pre-programmed path, but the control unit 8 is also operable (in cooperation with the processor unit 3) to servo movement of the machine in dependence on the measurements from the sensor unit 10 (these sensor measurements act as the feedback in a servo loop) so as to attempt to maintain substantially constant measurements from the sensor unit 10 for each of the sensor unit positions along the beam 21. This alternative approach is illustrated in FIG. 15, where the sensor readings are actively maintained at [2, 2] under servo control for the entire run. Of course, the sensor readings need not be maintained at [2, 2] but could instead be maintained at [1, 2] as shown in FIG. 16, or any other set of sensor readings. In any such case, it is known that the sensor unit 10 is moving along a straight line and at a constant angle relative to the beam 21, and any adjustments from the servo control are to counteract the effect of calibration errors.

For this alternative servo approach, a similar analysis can be made regarding adjustment of the model parameters as with the previous approach, in that it involves a comparison between the actual measurements from the sensor unit 10 and the expected measurements from the sensor unit 10. In this case, the actual measurement is always [2, 2] due to the servo control, and the expected measurement for a particular sensor unit position would be based on where the sensor unit 10 would be expected to be using the same position demands (as adjusted by the servo control) that resulted in the actual measurement of [2, 2] for that sensor unit position, based on the existing set of model parameters which characterises the geometry of the machine. Based on this comparison, the processor unit 30 updates the model parameters so as to provide a closer match between the expected measurements and the actual measurements, such that the updated model parameters represent the geometry of the machine better than the previous version of the model parameters.

The servo approach is advantageous because it means that it is not necessary to calibrate the sensors 11, 12 themselves, since the beam remains mostly static on a single point on both sensors 11, 12, with any small deviations being quickly corrected by the servo control. Advantageously, the position signal from one of the sensors 11, 12 can be used to control X, Y during the servo motion, while the position signal from the other of the sensors 11, 12 can be used to control ‘yaw’ and ‘pitch’ of the head (taking account of the position signal from the other sensor as well as the separation between sensors to work out the angle). Also, as also mentioned above in relation to the first approach, for the servo approach it is also not necessary to measure the separation between sensors 11, 12 to a high accuracy, since it is more important that the separation between the sensors is fixed, rather than knowing precisely what the separation is. For example, an accuracy of no more than 1 mm may be sufficient for a sensor separation of 100 mm. This because for servo control to be effective it is not necessary to know the precise angle, since the servo is effectively based on making small changes to the angle (and seeing what effect this has on the sensor measurements) rather than commanding a precise absolute angle. This is an advantage of a method according to an embodiment of the present invention, since it is only required to have a fixed, though not accurately known, separation.

FIG. 17 shows a sensor unit 10 in a similar form to that shown in FIG. 6, though with sensors 11, 12 conveniently mounted to an external surface for each of access and maintenance. FIG. 17, like FIG. 6, shows a normal path for the laser beam 21 through the sensor unit 10 and onto both sensors 11, 12. An alternative beam path is shown in FIG. 18, beam incident on the beam splitter 13 from the opposite side to the first sensor 11, with a proportion of the beam 21 passing through to the first sensor 11 and the remainder being directed up to the mirror 14 and then reflected across to the second sensor 12. The sensor unit 10 therefore has multiple entry points for the beam 21, at different respective angles, while still passing through the same sensor measurement positions. This is advantageous because it enables a first calibration run to be performed with the laser beam 21 using a first internal path (with the beam entering at a first angle), and for a second calibration run to be performed with the laser beam 21 in the same orientation but using a second internal path through the sensor unit 10 (and with the beam entering at a second angle different to the first angle). The robot arm 1 will be using a series of very different poses for the first run compared to the second run, and accordingly the overall calibration will be more complete (in a similar way to FIGS. 8 and 9).

A method for measuring the separation between the sensors 11, 12 will now be described with reference to FIG. 19, which shows a sensor unit like that also shown in FIGS. 17 and 18. The robot arm 1 is first controlled to move the sensor unit 10 so that the laser beam 21 passes at an angle through the sensor unit along first path 22, so that it is incident directly on the first sensor 11 without passing through the beam splitter 13. The precise entry angle is not important, so long as the beam misses any internal components; for example, any path in a cone formed by rotating path 22 around the line joining mirror 14 to sensor 12 would suffice. If the mirror 14 were instead a beam splitter, then it would also be possible to pass this beam directly through the beam splitter as a continuation of the line joining mirror 14 to sensor 12. The robot arm 1 is then controlled to move the sensor unit 10 so that the laser beam 21 passes through the sensor unit 10 along second path 23 (at the same angle as path 22), so that it is incident directly on the second sensor 12 without being blocked by the mirror 14. The separation between the two sensors 11, 12 can then be determined as the distance moved by the sensor unit 10. This is a sufficiently accurate measure of the separation between sensors 11, 12, even based on a rough calibration of the robot arm 1, because as mentioned above it is not critical to know this separation with high precision.

FIG. 20 is a three-dimensional representation of two sensors 11, 12 (forming part of the sensor unit 10) of a type shown in FIG. 4B, with these sensors 11, 12. For simplicity, these are shown in an inline arrangement along the laser beam 21 (like in FIG. 3) rather than in an offset arrangement (like in FIG. 6). Each of the sensors 11, 12 is a two-dimensional sensor, measuring a transverse (or lateral) position of the laser beam 21 in two directions (or dimensions) X and Y. However, it will be appreciated that each of the two-dimensional sensor 11, 12 can be formed from two one-dimensional sensors, as shown in FIG. 21. In the sensor arrangement of FIG. 21, the first two-dimensional sensor 11 is formed of a first one-dimensional sensor 11x for measuring the beam position in an X direction, and a second one-dimensional sensor 11y for measuring the beam position in a Y direction. Together, the position measurements from these two sensors 11x, 11y can be used to provide a two-dimensional position of the beam 21. Similarly, the second two-dimensional sensor 12 is formed of a first one-dimensional sensor 12x for measuring the beam position in an X direction, and a second one-dimensional sensor 12y for measuring the beam position in a Y direction. Of course, it would also be possible to use a two-dimensional sensor for one of sensors 11, 12 and two one-dimensional sensors for the other of sensors 11, 12.

FIG. 22 shows a sensor arrangement for a sensor unit 10 that is operable, for each of a plurality of sensor unit positions along the beam 21, to measure a transverse beam position at three measurement positions Y1, X1, Y2 along the beam 21 (where measurement position ‘X1’ is denoted by an ‘X’ in the upper-left corner and a ‘1’ in the lower-right corner). From these three measurements, a position of the sensor unit 10 relative to the beam 21 (or launch unit 20) can be derived in three degrees of freedom (3DOF): two transverse translational degrees of freedom (along transverse axes X, Y, where axis Z is a longitudinal axis) and one transverse rotational degree of freedom (around the X transverse axis, also known as ‘pitch’). Of these three degrees of freedom, the two translational degrees of freedom X, Y are derivable from X and Y measurements taken respectively at measurement positions X1 and Y1, while the rotational degree of freedom is derivable from Y measurements taken at the two spaced-apart measurement positions Y1 and Y2. The pitch angle θ can be determined from the separation dY between these two measurement positions Y1, Y2 and the difference y in position measurements from these measurement positions Y1, Y2 (as also discussed above with reference to FIG. 12):

$$θ = {tan}^{- 1} ( \frac{y}{dY} )$$

In the arrangement shown in FIG. 22, measurement positions X1 and Y1 could be coincident (with a single two-dimensional sensor) or substantially coincident (but with two separate one-dimensional sensors) or spaced apart (and with two separate one-dimensional sensors).

Compared to FIG. 22, the sensor arrangement shown in FIG. 23 includes a fourth measurement position X2 providing transverse beam position measurements in an X direction (or dimension). With the addition of this fourth measurement position X2, a position of the sensor unit 10 relative to the beam 21 (or launch unit 20) can now be derived in four degrees of freedom (4DOF), with ‘yaw’ (which is rotation around the Y transverse axis) also being derivable in an analogous way to that described with reference to FIG. 22 for ‘pitch’. Again, measurement positions X2 and Y2 could be coincident (with a single two-dimensional sensor) or substantially coincident (but with two separate one-dimensional sensors) or spaced apart (and with two separate one-dimensional sensors). The sensor arrangements of FIG. 22 and FIG. 23 both constitute embodiments of the present invention.

Referring again to FIG. 22, it will be apparent that the sensor at position Y2 could be rotated by 90 degrees to provide an additional position X2 (as there is in FIG. 23), and thereby providing relative positional information in four degrees of freedom (4DOF) rather than three (3DOF). This rotation could be done for each sensor unit position in a single run, moving to a new sensor unit position, measuring at measurement position Y2, then rotating to create measurement position X2, then moving to the next sensor unit position, measuring X2, then rotating to create Y2, measuring, and so on. Or a complete run along the laser beam 21 could be performed with the Y2 configuration, and another run performed with the X2 configuration, taking measurements at the same sensor unit positions along the beam 21.

This concept is explored further with the sensor unit 10 shown in FIGS. 24A and 24B, which has a single two-dimensional sensor 12 that is moveable between two (e.g. kinematically-defined) positions 15 and 16 (effectively creating two sensors 11 and 12 in those positions) by a piston 17. The positions 15 and 16 are separated by a fixed distance. This concept is extended further in FIG. 24C, which has a single one-dimensional sensor 11 which is both moveable between the two fixed positions 15 and 16 and also rotatable between two fixed angular positions, thereby providing all four measurement positions X1, Y1, X2, Y2 of FIG. 23 using just a single one-dimensional sensor.

Rather moving the sensor itself, it would also be possible to achieve this by optical means, e.g. by moving an optical component between two positions to create two different path lengths for the laser to the same sensor in the same position, or by switching in a delay line or extra optical path, or by switching in an extra component to increase the optical path length. Just one example is shown in FIGS. 25A and 25B, which has a single two-dimensional sensor 11, a mirror 19 facing the sensor 11, and a beam splitter 13 mounted on a rotational stage 25. The beam splitter 13 can be rotated from a first position shown in FIG. 25A, in which the beam 21 is directed directly to the sensor 11, to a second position shown in FIG. 25B, in which the beam 21 is directed across to the mirror 19 and then back to the sensor 11. This effectively creates two measurement positions for the sensor unit 10 and is therefore equivalent to the embodiment shown e.g. in FIGS. 3, 5 and 6. Of course, the two-dimensional sensor 11 of FIGS. 25A and 25B could be replaced by a one-dimensional sensor and means for rotating the one-dimensional sensor by 90 degrees, thereby recreating all four measurement positions illustrated in FIG. 23 using just a single one-dimensional sensor.

A particular advantage associated with a sensor arrangement like that of FIG. 6, with sensors 11, 12 (and more particularly sensor 12) to one side of the incoming beam 21, will now be described with reference to FIGS. 26 and 27. With the distance between the mirror 14 and the sensor 12 is denoted as ‘d’, when the optical path for the beam 21 after the beam splitter 13 is “unfolded” it is apparent that sensor 12 is effectively in line with the input beam 21 and at a position beyond mirror 14 by the same distance ‘d’ from the mirror 14, marked as (12) in FIG. 26 (a similar “unfolding” can be performed in respect of the other sensor 11 to show where it would be if it were in line with the input beam 21). This enables the sensor 12 effectively to be positioned outside the main housing of the sensor unit 10, as depicted in FIG. 26. Consequently, this creates room for a rotary joint 18 to be used to form a coupling between the sensor unit 10 and the robot arm 1. The rotary joint 18 may have a plurality of indexed rotary positions or it may be continuously adjustable. Furthermore, the rotation centre of the rotary joint 18 is preferably arranged to be coincident with the effective sensor position (12), so that the sensor unit 10 can be rotated around the rotary joint 18 to change the orientation of the sensor 12 without also moving (translating) the sensor 12 in X, Y, Z. Even more advantageously, the rotation centre of the rotary joint 18 can also arranged to be coincident with a position of interest of the robot arm 1, such as a tool centre point (TCP), when the sensor unit is mounted to the robot arm 1, as will now be explained with reference to FIGS. 28 to 31.

FIG. 28 shows the sensor unit 10 coupled to the robot arm 1 via the rotary joint 18, with the rotary joint coupling being designed so as to place the centre of the rotary joint 18 coincident with the currently-programmed TCP for the robot arm 1. As described above, the robot arm 1 is then controlled to perform move the sensor unit 10 along the beam 21. In general, robot control is complex because of the way in which the various rotary joints 5, 6 interact and combine, but it is relatively straightforward to command the robot arm 1 in relation to the current TCP, e.g. to translate the TCP in X, Y, Z or to rotate the head of the robot in A, B, C around the TCP (i.e. keeping the TCP in the same position in X, Y, Z). Therefore, having the sensor 12 effectively coincident with the TCP enables the robot arm 1 to be controlled more easily as it moves along the beam 21, since the position of the sensor 12 in X, Y, Z can controlled via the TCP and the orientation of the sensor unit 10 as a whole can likewise be controlled separately by commanding the robot arm 1 to rotate around the TCP in A, B, C (without also changing the position of sensor 12 in X, Y, Z), i.e. translation and rotation can be treated and controlled independently.

As shown in FIG. 29, the sensor unit 10 can then be rotated around the rotary joint 18 so that another run can be performed for the same orientation of beam 21, thereby exercising the rotary joints 5, 6 in different combinations compared to the run performed in FIG. 28, and thereby providing a better overall calibration for the robot arm 1. FIG. 30 shows another run being performed with the beam 21 launched from the same position but at a different angle, while FIG. 31 shows another run being performed with the beam 21 launched from a different position, in each case with the rotary joint 18 allowing the sensor unit 10 to be mounted to the robot arm 1 in a flexible manner at a different angle relative to the head of the robot arm 1.

It is to be noted that the above-mentioned benefit of arranging for the sensor 12 to be substantially coincident with the TCP applies independently of the presence or otherwise of the rotary joint 18. In other words, even for a coupling between the machine 1 and the sensor unit 10 that does not have a rotary joint, such as is shown in FIG. 3, it is beneficial for the same reasons as stated above to arrange for one of the two sensors 11, 12 (conveniently sensor 12 that lies closest to the machine 1) to be coincident with the TCP when the sensor unit 10 is coupled to the machine 1.

It is also to be noted that the concept as shown in FIGS. 28 to 31 has independent applicability to any directional sensor unit that is mounted to a non-Cartesian machine in a fixed orientation to perform a method for characterising the machine, and which can be moved between a plurality of different fixed orientations relative to the machine (and which may also be operable in a plurality of different sensing directions similar to what is shown in FIGS. 17 and 18) to enable the method to be performed with the machine in a plurality of different configurations for the same sensing operations. This is particularly applicable where the sensor unit is of a type that is capable of taking measurements from which a position of the sensor unit relative to the beam is derivable in at least three degrees of freedom (3+DOF).

US 2016/0243703 A1 describes system in which a single laser beam interacts with a single sensor, and from this it is not possible to derive any information about a relative rotational degree of freedom for use in the calibration. Even where two sensors and two laser beams are used, the separation between the sensors is neither fixed nor known so it is still not possible to derive information relative rotational degree of freedom. Unlike US 2016/0243703 A1, an embodiment of the present invention is conveniently able to measure relative motion in at least three degrees of freedom (preferably four) using just a single laser beam.

The XM-60 calibration device made and sold by Renishaw plc is designed to measure relative motion of a receiver unit relative to a launch unit in all six degrees of freedom (6DOF), for machine calibration purposes. However, this calibration device requires four laser beams to be launched from the launch unit. The fourth beam is incident on a two-dimensional sensor, is used to measure horizontal and vertical straightness based on how the beam moves in X, Y directions on the sensor as the receiver unit moves along the beam. This fourth beam is also used to measure roll (rotation around the longitudinal axis of the beam) by sensing how a linear polarisation of the beam rotates as the receiver unit moves along the beam. The other three degrees of freedom (pitch, yaw, linear straightness) are determined interferometrically from the other three laser beams, by measuring distance (or changes in distance) and determining pitch, yaw, and linear straightness from those.

Unlike the XM-60, an embodiment of the present invention is conveniently able to measure relative motion in four degrees of freedom (4DOF) using just a single laser beam rather than four. An embodiment of the present invention could be augmented by adding a roll sensor like that used in the XM-60, such that relative position can be measured in five degrees of freedom (X, Y, pitch, roll, yaw) using just a single laser beam. Such a roll sensor is described in WO 2008/122808, which is incorporated herein by reference. The only degree of freedom (of the six degrees of freedom) that would then be missing is a measurement of linear straightness, i.e. along the laser beam (the Z axis in the coordinate system shown in FIG. 23).

Referring back to FIG. 19, with reference to which it was described that the robot 1 can itself be used to measure the separation between sensors 11, 12, if the separation between sensors 11, 12 is known by some other means, e.g. measured by a separate coordinate measuring machine, then this known separation can be used to provide measurement information relating to the final linear degree of freedom (along the beam). This can be achieved by moving the sensor unit 10 along the main beam path 21 shown in FIG. 19, but with the beam 21 entering the sensor unit 10 at an angle corresponding to paths 22, 23, so that the angled beam 21 is in turn incident on sensors 11 and 12 (via paths 22, 23 respectively) in either order. The known separation between sensors 11, 12 can then be used to calibrate or otherwise characterise the linear degree of freedom along path 21.

A calibration system embodying the present invention could also be provided with a separate linear measurement device (or strut or ballbar) 41 to enable calibration of this final degree of freedom, as shown in FIG. 32. Such a linear measurement device 41 is described in detail in our related WO 2019/162697 which is incorporated herein by reference. The linear measurement device 41 can be mounted to the robot arm 1 in place of the sensor unit 10, for collecting measurements along the longitudinal axis (i.e. where the laser beam 21 would have been). Measurements can be collected with the linear measurement device 41 in a variety of different orientations, so that the joints of the robot 1 will accordingly also be in a wider variety of states for an improved overall calibration.

WO 2019/162697 also describes how the linear measurement device 41 can advantageously be mounted, as also shown in FIG. 32, via a ball adaptor 44 and a corresponding coupling 47 on the linear measurement device 41, enabling the linear measurement device 41 to pivot exactly around the TCP 48. The ball adaptor 44 attaches to the robot arm 1, enabling the tool (e.g. welding tool) to remain in place on the robot arm 1 even while the calibration is being performed, with the centre of the ball adaptor 44 being coincident with the TCP 48. The other end of the linear measurement device 41 has a ball 45 which couples rotatably to a mount 42. Further detail of this ball adaptor concept can be found in WO 2019/162697.

As shown in FIG. 33, the ball adaptor 44 of FIG. 32 can also be used to mount the sensor unit 10 itself, by providing the sensor unit 10 with an internal (e.g. kinematic) cup 81, and with the sensor unit 10 coupling magnetically to the ball adaptor 44 via the internal cup 81. The internal cup 81 has a generally part-spherical concave surface, with a radius matching that of the ball adaptor 44 (the internal cup 81 would preferably be provided with kinematic contact features as described in WO 2019/162697). The centre of the part-spherical surface of the internal cup 81 is also arranged to be coincident with the effective position of sensor 12, so that the sensor unit 10 can be moved around the ball adaptor 44 to change the orientation of the sensor 12 without also moving (translating) the sensor 12 in X, Y, Z, very similar to what is described above with reference to FIGS. 26 and 27. Since the centre of the ball adaptor 44 is coincident with the TCP, as described above, the sensor 12 itself is also then coincident with the TCP and remains so as it is moved around the ball adaptor 44 into different orientations. With a sufficiently strong magnetic coupling force between the sensor unit 10 and the ball adaptor 44, there would be no need for any additional holding feature, which is feasible in practice because the sensor unit 10 is contactless and would not therefore be subject to any destabilising force (other than the force of gravity and the force of acceleration, both of which would generally be manageable).

Instead of using a separate linear measurement device (or ballbar) 41 for the sixth (linear) degree of freedom, some of the beam 21 could instead be returned back to the launch unit 20 (e.g. by use of a retroreflector in the sensor unit 10) so that the sixth (linear) degree of freedom can be determined interferometrically, i.e. based on interference between the return (measurement) beam and a reference beam as would be well known (and as is used in the XM-60 and XL-80 calibration devices made and sold by Renishaw plc).

The above description has focused on a system for calibrating a machine (such as a robot arm), i.e. not only identifying errors associated with a parametric model used to characterise the machine geometry but also correcting or accounting for those errors to provide a better calibration. It is also possible to use the technique for identifying or assessing machine errors and not actually correcting them as such, for example as part of a machine verification procedure to assess the overall performance of a machine. The technique can also be used when setting up a machine. Accordingly, it should be considered that the present invention relates to a system and method for characterising a machine in a general sense, which includes calibration, verification and so on.

In the various embodiments illustrated and described herein, the processor unit 30 is shown as forming part of the controller 8, but the processor unit 30 could be separate and/or remote from the controller 8. For example, the measurement data could be sent to a remote site for processing rather than processed on site. The processor unit 30 is intended to represent means for providing additional functionality associated with an embodiment of the present invention and that is not provided by a conventional controller, either additional functionality for the controller (e.g. to provide the servo control described above when collecting measurement data) or additional functionality outside the controller (e.g. offsite processing of the collected measurement data).

A calibration system embodying the present invention has the advantage of using an optical (i.e. non-contact) coupling between the moving and fixed parts of the machine, and accordingly it introduces no extra loading which might otherwise affect the accuracy of the measurements (and therefore the effectiveness of the resulting machine calibration or verification), as would be the case with a mechanical form of multi-dimensional measuring arm. The sensor unit 10 itself can be of very lightweight construction so that it does not provide any significant additional loading due to its weight, and the tool can be left in place while doing this calibration, just attaching the sensor unit 10 during a quick calibration routine with the loading of the robot arm 1 being substantially the same as it would be in actual use.

Sensor measurements can be taken only when the sensor unit 10 is moving, or only when static, or a combination. It would be possible to add a motion sensor, such as an accelerometer, to sense when the sensor unit 10 is moving, in order to ensure that measurements only taken when moving or only when static. Such a motion sensor could also be used to compensate out vibrational effects caused by imperfections in the machine's drive system, or other environmental factors that might case machine vibration. It would also be advantageous to measure the ambient light level (e.g. based on a comparison between sensor readings with the laser beam 21 switched on and off) and to compensate out the ambient light level from the sensor readings.

Although it is described above that the sensor unit 10 is mounted to the moveable element of the machine, with the launch unit 20 mounted to the fixed base 2 of the machine, it would also be possible to reverse this so that the launch unit 20 is mounted to the moving element and the sensor unit 10 mounted to the base 2, as shown in FIG. 34. However, it is considered to be preferable to have the sensor unit 10 mounted to the moving element because, with the launch unit 20 mounted to the moving element instead, small unintended angular changes to the moving element of the machine e.g. due to machine vibration would lead to large positional changes at the far end of the laser beam (this would be particularly apparent in the case of a robot arm) but this could be mitigated by use of a larger sensor (capable of measuring a wider range of lateral beam positions).

Although the two two-dimensional sensors 11, 12 in FIG. 20 (and the equivalent in FIGS. 21, 22, 23) are shown as having X and Y axes that are aligned, it would also be possible to have sensors 11, 12 with axes that are rotated relative to one another, so that their axes are not aligned. In this case the angle between them would also need to be known (with the arrangement shown in FIG. 20 it is assumed that the angle is zero, i.e. it is known but zero).

A method of calibrating or otherwise characterising a machine according to an embodiment of the present invention is summarised in the flowchart of FIG. 35. In step S1, a laser beam is launched into a working volume of the machine from a launch unit. In step S2, the machine is controlled to move a sensor unit along the laser beam relative to the launch unit to a plurality of sensor unit positions along the beam; either the sensor unit or the launch unit could be moved by the machine but preferably the sensor unit. In step S3, for each of the plurality of sensor unit positions the sensor unit is used to take measurements from which a position of the sensor unit relative to the beam is derivable in at least three degrees of freedom (3+DOF). In step S4 it is determined whether sufficient measurements have been taken. If not, in step S5 the position and/or direction of the beam is changed, and the method returns to step S1 to collect further measurements along the beam in its new position and/or orientation. If so, then in step S6 the measurements are used to calibrate or otherwise characterise the machine. It is noted that such a method has not been previously considered for the characterisation (e.g. calibration) of a non-Cartesian coordinate positioning machine (particularly an articulated robot arm) that does not comprise a series of fixed linear axes (like in a three-axis Cartesian CMM), regardless of whether the sensor unit is of a type as previously described herein (see e.g. FIG. 6); it is sufficient that the sensor unit is of any type that is capable of taking measurements from which a position of the sensor unit relative to the beam is derivable in at least three degrees of freedom. For example, the XM-60 device made and sold by Renishaw plc (see above for more information) would be suitable for use as the sensor unit in such a method. The XM-60 is generally aimed at separately calibrating each of the three linear axes of a Cartesian CMM but the present applicant has appreciated that such a calibration device could be used in this context to collect measurements in six degrees of freedom (6DOF) along multiple lines across a working volume, none of which lines correspond to an actual machine axis.

Although described mainly in connection with the characterisation (e.g. calibration) of an articulated robot arm, it will be appreciated that an embodiment of the present invention is applicable to the characterisation (e.g. calibration) of any type of coordinate positioning machine, for example including the various types as described in the opening part of the present application, whether non-Cartesian or Cartesian, and whether serial kinematic or parallel kinematic. An embodiment of the present invention is even applicable to the characterisation of a single machine axis, e.g. a single axis of a three-axis Cartesian CMM. This extends to an example, as shown in FIG. 36, in which a robot arm 1 is mounted to a linear rail 40 (or linear axis), in which case a sensor unit 10 as described herein can be mounted to the robot arm 1, and the entire robot arm 1 moved along the rail 40 (with the robot joints locked) with the sensor unit 10 moving along the laser 21 launched from the launch unit 20, effectively amounting to a characterisation of the linear axis of the rail 40 on which the robot arm 1 is mounted; this is to be understood as constituting an embodiment of the present invention since the machine being calibrated or otherwise characterised in this example includes the linear axis provided by the rail 40.

FIG. 37 shows how performing two (first and second) runs of the sensor unit 10 along the same beam 21 (i.e. launched at the same angle from the same position) can be used to determine a roll degree of freedom, as an alternative to using a dedicated roll sensor as described above. The illustration of FIG. 37 is based on a two-dimensional sensor of a type shown in FIG. 4A but of course any suitable sensor of combination of sensors as described herein can be used. In the second run, the sensor unit 10 is moved by the robot arm 1 along a path that is shifted laterally relative to the beam 21 compared to the path for the first run. The sensor readings from both runs can be used to derive information relating to a roll degree of freedom for each sensor unit position. FIG. 38 illustrates how the same sensor readings as FIG. 37 would be interpreted as a translation if just one of the beam runs is performed. It would also be possible to use a pair of beams 21 so that only a single run would need to be performed along the beam pair, but this would require the beams to be parallel or at least at a known angle relative to one another, which may be more difficult in practice to achieve.

Where it is described herein that a position of the sensor unit 10 relative to the beam 21 is derivable from the measurements in at least three degrees of freedom, it will be appreciated that this does not imply that such a position is actually derived or determined or calculated from the measurements in any or all of these degrees of freedom, as part of the method. It is merely necessary that such a position of the sensor unit relative to the beam is able to be derived from the measurements, because this means that the measurements encapsulate sufficient positional information to enable the machine to be calibrated or otherwise characterised. For example, in the case of a calibration routine to update a set of model parameters for the machine, the set of raw measurements could be processed directly, as part of an iterative error minimisation algorithm, without ever deriving (e.g. as an intermediate step) an actual position of the sensor unit relative to the beam in each of the at least three degrees of freedom. So, in the example shown in FIG. 12, an actual numerical value for 0 may not be determined as part of the method, even though this angular information is implicitly used in the method via the lateral position measurements from the spaced-apart sensors 11, 12.

The above embodiments have been based on a laser beam 21 being used as a guide along which the sensor unit 10 is moved. It will be appreciated that the present invention is not limited to the use of a laser beam specifically. Any optical beam could be used, whether or not it has the properties of a laser beam. For example, a normal (non-laser) light beam could be used and sensed in a similar way. The optical beam is effectively acting as an optical guide that can be sensed by an appropriate form of sensor in the sensor unit. The present invention is not even limited to the use of an optical beam as the guide. Some other type of energy beam could be used instead, such as an electron beam, with use of appropriate sensors in the sensor unit depending on the type of energy beam used. In this sense, the exact form of guide is not relevant, since all that is required is that a guide is arranged in the working volume, and that the sensor unit is moveable by the machine to a plurality of sensor unit positions along the guide and is operable, for each of the plurality of sensor unit positions, to measure a transverse position of the guide (by whatever means appropriate for the type of guide being used) at a plurality of measurement positions along the guide, with a position of the sensor unit relative to the guide being derivable from the measurements in at least three degrees of freedom. Preferably a non-contact form of guide is used, but a mechanical guide could also be used, such as a metal rod or the straight edge of a rigid metal sheet (like a ruler), with the sensors being of a type (e.g. linear variable differential transformer or LVDT sensors) to measure a lateral position relative to the guide. The guide need not even be straight, but merely of a known form. Therefore, although the use of a laser beam is a very convenient way of providing a non-contact guide that is of a known form (i.e. straight), other forms of guide are to be understood as being within the scope of the present invention.

A machine controller for controlling the operation of the robot (or other type of coordinate positioning machine) may be a dedicated electronic control system and/or may comprise a computer operating under control of a computer program. For example, the machine controller may comprise a real-time controller to provide low-level instructions to the coordinate positioning machine, and a PC to operate the real-time controller. It will be appreciated that operation of the coordinate positioning machine can be controlled by a program operating on the machine, and in particular by a program operating on a coordinate positioning machine controller such as the controller 8. Such a program can be stored on a computer-readable medium, or could, for example, be embodied in a signal such as a downloadable data signal provided from an Internet website. The appended claims are to be interpreted as covering a program by itself, or as a record on a carrier, or as a signal, or in any other form.

1. A system for characterising a machine, comprising:
a launch unit which is operable to launch an optical beam into a working volume of the machine;
a sensor unit which is moveable by the machine to a plurality of sensor unit positions along the beam, and which is operable, for each of the plurality of sensor unit positions, to measure a transverse beam position at a plurality of measurement positions along the beam, with a position of the sensor unit relative to the beam in at least three degrees of freedom being derivable from the measurements; and
a processor unit which is operable to use the measurements to characterise the machine.

2. A system as claimed in claim 1, wherein a position of the sensor unit relative to the beam is derivable in two transverse translational degrees of freedom and at least one transverse rotational degree of freedom.

3. A system as claimed in claim 2, wherein a position of the sensor unit relative to the beam in the transverse rotational degree of freedom is derivable from a corresponding pair of measurement positions that are spaced apart by a fixed separation.

4. A system as claimed in claim 2, wherein a position of the sensor unit relative to the beam is derivable in two transverse rotational degrees of freedom.

5. A system as claimed in claim 1, wherein the sensor unit is further operable to provide further measurements from which a position of the sensor unit relative to the beam is derivable in a longitudinal rotational degree of freedom.

6. A system as claimed in claim 1, wherein the processor unit is operable to characterise the machine in dependence on a comparison between expected measurements from the sensor unit and the actual measurements from the sensor unit.

7. A system as claimed in claim 6, wherein the geometry of the machine is characterised by a set of model parameters.

8. A system as claimed in claim 7, wherein the processor unit is operable to update the model parameters based on the comparison.

9. A system as claimed in claim 7, wherein characterising the machine comprises determining a new set of model parameters that characterises the geometry of the machine better than an existing set of model parameters.

10. A system as claimed in claim 7, comprising a control unit that is operable to control the machine to move the sensor unit along the beam.

11. A system as claimed in claim 10, wherein the control unit is operable to control the machine to move the sensor unit along the beam based on the set of model parameters.

12. A system as claimed in claim 10, wherein the control unit is operable to control movement of the machine to cause the sensor unit to follow a predetermined path along the beam.

13. A system as claimed in claim 10, wherein the control unit is operable to servo movement of the machine in dependence on the measurements from the sensor unit to maintain substantially constant measurements from the sensor unit for each of the sensor unit positions along the beam.

14. A system as claimed in claim 10, wherein the control unit is operable to move the sensor unit relative to the launch unit such that the beam is incident at each measurement position of the pair in turn, and wherein the processor unit is operable to determine the separation based on the model parameters.

15. A system as claimed in claim 10, wherein the processor unit is separate from the control unit.

16. A system as claimed in claim 1, wherein the sensor unit comprises a sensor at each of the measurement positions, each sensor being adapted to sense the beam in one or two transverse dimensions or directions.

17. A system as claimed in claim 1, wherein the sensor unit has multiple entry points for the beam at different respective angles while still passing through the same measurement positions.

18. A system as claimed in claim 1, wherein a coupling between the sensor unit and the machine is adapted to place at least one of the measurement positions substantially coincident with a point of interest associated with the machine.

19. A system as claimed in claim 18, wherein the point of interest associated with the machine is a tool centre point.

20. A system as claimed in claim 1, wherein a coupling between the sensor unit and the machine is adapted to enable rotation of the sensor unit relative to the machine around a predetermined point on the coupling.

21. A system as claimed in claim 20, wherein the predetermined point is substantially coincident with the point of interest.

22. A system as claimed in claim 1, wherein the launch unit is operable to launch the beam into the working volume of the machine from multiple positions and/or in multiple directions.

23. A system as claimed in claim 1, wherein the sensor unit is moved by the machine while the launch unit is fixed, or wherein the launch unit is moved by the machine while the sensor unit is fixed.

24. A system as claimed in claim 1, wherein the optical beam is a laser beam or some other type of energy beam, such as a light beam or an electron beam, or some other form of guide such as a non-contact and/or optical guide or even a mechanical guide such as the straight edge of a rigid structure.

25. A system as claimed in claim 1,
further comprising a linear measurement device for providing measurements relating to a longitudinal translational degree of freedom.

26. A system as claimed in claim 1, wherein the sensor unit comprises a reflector for returning at least a proportion of the beam back to the launch unit, and wherein the launch unit comprises an interferometric sensor which uses a reference beam and the return beam to provide measurements relating to a longitudinal translational degree of freedom.

27. A system as claimed in claim 1, wherein characterising the machine comprises one or more of: calibrating the machine; verifying the machine; performing a health check of the machine; evaluating positioning errors of the machine; and setting up the machine.

28. A system as claimed in claim 1, wherein the machine comprises a coordinate positioning machine.

29. A system as claimed in claim 1, wherein the machine comprises a non-Cartesian and/or parallel kinematic machine.

30. A system as claimed in claim 1, wherein the machine comprises a robot arm.

31. A sensor unit for use in a system as claimed in claim 1, the sensor unit being moveable by the machine to a plurality of sensor unit positions along the beam, and which is operable, for each of the plurality of sensor unit positions, to measure a transverse beam position at a plurality of measurement positions along the beam, with a position of the sensor unit relative to the beam in at least three degrees of freedom being derivable from the measurements.

32. A directional sensor unit that is mountable to a non-Cartesian machine in a fixed orientation to perform a method for characterising the machine, and which is moveable between a plurality of different fixed orientations relative to the machine to enable the method to be performed with the machine in a plurality of different configurations for the same sensing operations.

33. A method of characterising a machine, comprising:
(a) launching an optical beam into a working volume of the machine;
(b) controlling the machine to move a sensor unit along the beam to a plurality of sensor unit positions along the beam;
(c) for each of the plurality of sensor unit positions, using the sensor unit to measure a transverse beam position at a plurality of measurement positions along the beam, with a position of the sensor unit relative to the beam in at least three degrees of freedom being derivable from the measurements; and
(d) using the measurements to characterise the machine.

34. A method as claimed in claim 33, comprising repeating steps (b) and (c) for the same beam launched in step (a) but using a path for the sensor unit path that is offset from the path for the sensor unit from a previous performance of steps (b) and (c), from which combination of measurements a position of the sensor unit relative to the beam is derivable in a rotational degree of freedom around an axis defined by the beam.

35. A method of characterising a non-Cartesian coordinate positioning machine, comprising:
(a) launching an optical beam into a working volume of the machine;
(b) controlling the machine to move a sensor unit along the beam to a plurality of sensor unit positions along the beam;
(c) for each of the plurality of sensor unit positions, using the sensor unit to take measurements from which a position of the sensor unit relative to the beam is derivable in at least three degrees of freedom;
(d) repeating steps (a) to (c) for a plurality of different launch positions and/or angles for the beam; and
(e) using the measurements to characterise the machine.

36. A method as claimed in claim 33, wherein the sensor unit for use in the system being moveable by the machine to the plurality of sensor unit positions along the beam, and which is operable, for each of the plurality of sensor unit positions, to measure the transverse beam position at the plurality of measurement positions along the beam, with the position of the sensor unit relative to the beam in at least three degrees of freedom being derivable from the measurements.

37. A computer program which, when run by a computer or a machine controller, causes the computer or machine controller to perform a method as claimed in claim 33.

38. A computer-readable medium having stored therein computer program instructions for controlling a computer or a machine controller to perform a method as claimed in claim 33.

39. A machine controller configured to control a machine to perform a method as claimed in claim 33.
